(19) United States
(12) Patent Application Publication
(10) Pub. No.: US 2025/0139421 A1
(43) Pub. Date: May 1, 2025

(54) TESSELLATED SIMPLEXED PATTERN IDENTIFICATION PROCESSOR

(71) Applicant: Bank of America Corporation, Charlotte, NC (US)

(72) Inventors: Justin Horowitz, Fort Mill, SC (US); Melissa Podrazka, Chicago, IL (US)

(21) Appl. No.: 18/385,472

(22) Filed: Oct. 31, 2023

(51) Int. Cl. G06N 3/0495

(52) U.S. Cl. CPC G06N 3/0495

(57) ABSTRACT

Methods for operating a neural network on processors are provided. Methods may include creating a neural network. The neural network may include a plurality of neurons. Each neuron may represent a data point. Each neuron may be sorted in a hierarchical tree. The sorting may be based on attributes of the data points. The tree may include a plurality of decision forks. Each fork may represent a differentiator between a data point type that categorizes the data points. Methods may receive an additional data point to append to the tree. Methods may receive metadata relating to a categorization of the additional data point. Methods may convert the additional data point to a neuron. Methods may add the neuron to the tree at a bottom edge of the tree. Methods may flatten the tree into a flattened neuron network. Methods may replace the neural network with the flattened neural network.

### FIELD OF TECHNOLOGY

Aspects of the disclosure relate to transformer neural networks.

### BACKGROUND OF THE DISCLOSURE

Recently, very large amounts of data (referred to the industry as “big data”) combined with large amounts of electricity have created, and continuously create, capable technology products. These technology products include neural networks that are utilized in many different industries.

One limitation of neural networks is that the neural networks are relatively slow-learning. Another limitation is that because the neural networks are trained on big data, changes to a small number of data points, even though the data points represent significant attributes, are unable to rapidly change the course of the neural network. Therefore, neural networks trained on big data may be compared to changing the direction of a large cruise ship as opposed to changing the direction of a jet ski.

It would be desirable to use a neural network to represent a data universe, where each neuron within the neural network represents a data point, where the neural network is categorized like a hierarchical tree based on attributes and where each fork in the hierarchical tree represents a differentiator between a data point type. It should be further desirable for the neural network to be adjustable, in which additional data points (also referred to as nodes or leaves) can be added to the tree without the need to peruse the tree. It would be further desirable for a completed tree to be flattened out into a four-layer neural network. It would be further desirable to use parallel processing techniques to search the tree, in order to shorten processing time associated with processing a data point through the neural network. As such, it would be yet further desirable to create a neural network that can change direction in a short amount of time based on a small number of data points. Such a neural network can be compared to a jet ski, which can change direction easily and with little effort.

### SUMMARY OF THE DISCLOSURE

Systems, apparatus and methods for operating a neural network on one or more processors are provided. Methods may include creating a neural network. The neural network may represent a data universe.

The neural network may include a plurality of neurons. Each neuron within the neural network may represent a data point. Each of the neurons in the neural network may be sorted in a hierarchical tree. The sorting within the neural network may be based on attributes of the data points. The hierarchical tree may include a plurality of decision forks. Each decision fork may represent a differentiator between a data point type that categorizes the data points.

Methods may include receiving an additional data point to append to the hierarchical tree. Methods may include receiving metadata relating to a categorization of the additional data point. Methods may include converting the additional data point to a neuron. Methods may include adding or appending the neuron to the hierarchical tree at a bottom edge of the hierarchical tree.

Methods may include flattening out the hierarchical tree into a flattened neural network. Each decision fork in the hierarchical tree may be parallel to each other decision fork in the hierarchical tree.

The flattened neural network may include not more than four neuron layers. A first layer may correspond to an input layer. A second layer may correspond to a decision query included in the decision fork. A third layer may correspond to a decision response included in the decision fork. A fourth layer may correspond to an output layer. The output layer may combine the decision responses from the third layer. The output layer may also output a single output upon completion of the combination of the decision responses. The second layer and the third layer may be hidden layers. Parallel processing techniques may be used to process and search the flattened neural network. Therefore, the flattened neural network may be processed in a shorter time period than other tree processing techniques.

The output of the flattened neural network may be changed based on less than a predetermined number of added data points. The number of added data points may be one, five, ten, twenty or any other suitable number of added data points.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows yet another illustrative diagram in accordance with principles of the disclosure; and

FIG. 8 shows still yet another illustrative diagram in accordance with principles of the disclosure.

### DETAILED DESCRIPTION OF THE DISCLOSURE

Apparatus, methods and systems for a neural network representing a data universe may be provided. The neural network may include a plurality of neurons. Each neuron, included in the plurality of neurons, may represent a data point. Each neuron, included in the neural network, may be sorted in a hierarchical tree based on attributes of the data points. The hierarchical tree may include the plurality of neurons and a plurality of decision forks. Each decision fork, included in the hierarchical tree, represents a differentiator between a data point type that categorizes the data points.

The neural network may be operable to receive an additional data point to append to the hierarchical tree. The neural network may be operable to receive metadata relating to a categorization of the additional data point. The neural network may convert the additional data point to a neuron. The neural network may add the neuron to the hierarchical tree at a bottom edge of the hierarchical tree based on the categorization of the additional data point.

The neural network may be operable to convert the hierarchical tree into a flattened neural network. Each decision fork in the hierarchical tree may be parallel to each other decision fork in the hierarchical tree.

The flattened neural network may replace the neural network. The flattened neural network may be not greater than four neuron layers. The four neuron layers may include a first layer. The first layer may correspond to an input layer. The input layer may receive input relating to an uncategorized data point.

The second layer may correspond to a decision query included in the decision forks. The second layer may be a hidden layer. The second layer may query the uncategorized data point with respect to each decision included in the hierarchical tree.

The third layer may correspond to a decision response included in the decision forks. The third layer may be a hidden layer. The decision response may correspond to a decision of the query of the uncategorized data point. The decision response may be selected from the plurality of neurons.

The fourth layer may correspond to an output layer. The output layer may combine the decision responses from the third layer. The fourth layer may output a categorization of the uncategorized data point.

It should be noted that the learning may be non-iterative because the categorization output may land within a tessellated output zone. As such, each simplex that categorizes a grouping may be tessellated with another grouping. Therefore, there may not be space within the tessellated output zone for an unidentified categorization. It should be noted that new categories may be added to the hierarchical tree without perusing the tree (at the bottom edge of the tree). Such new categories may generate new simplexes that may be tessellated with the previously available simplexes. Therefore, such new categories may be considered within, or added to, the tessellated output zone.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

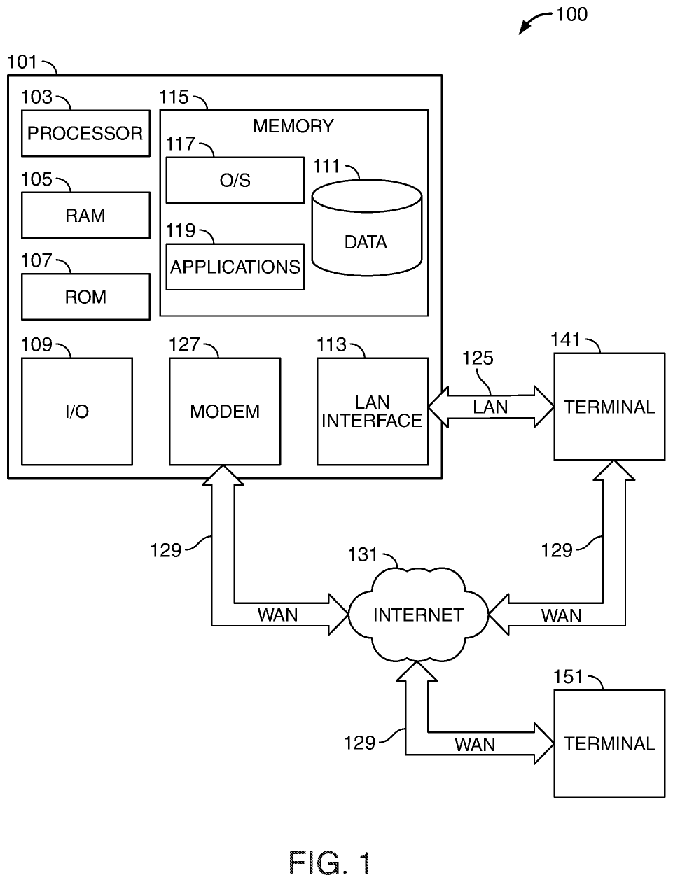

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files, nodes, servers, computing devices, User telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

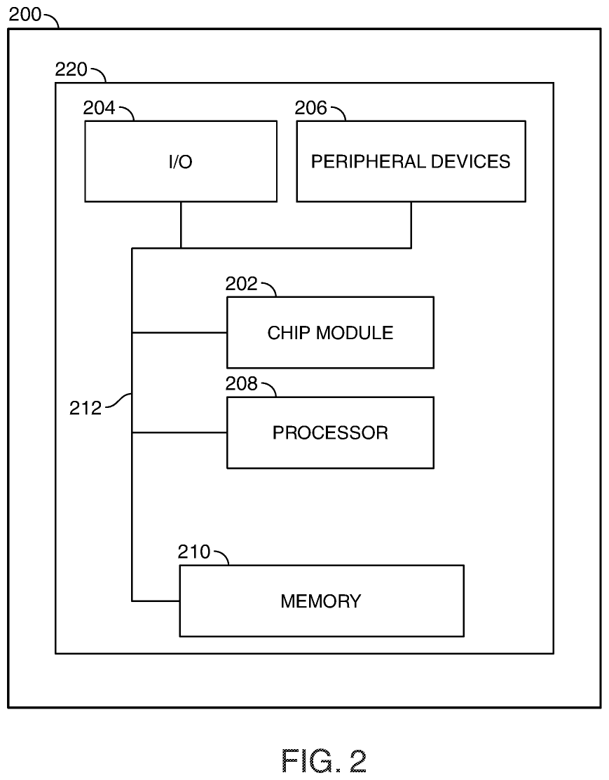

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

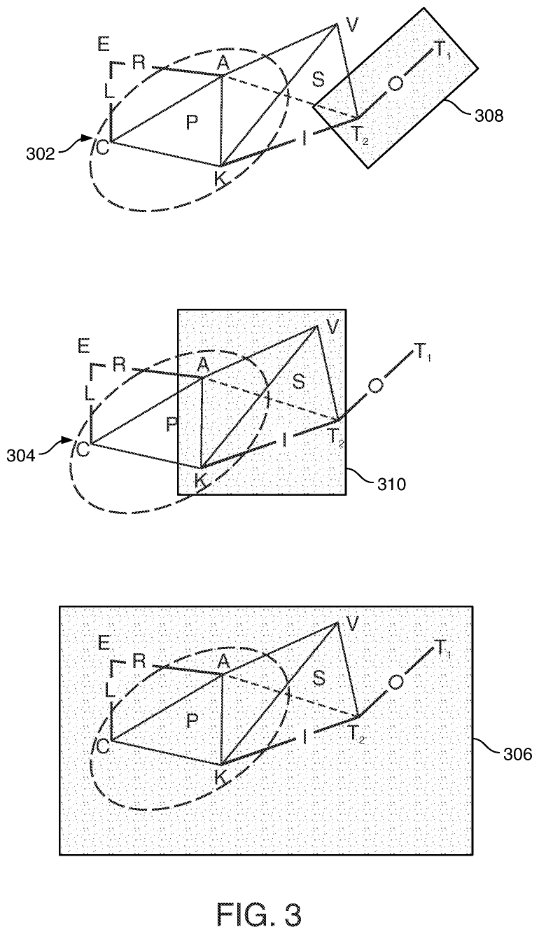

FIG. 3 shows an illustrative diagram. The illustrative diagram shows advances within pattern identification. Graph 302 may include multiple simplexes. Each simplex may represent one or more experiences. Section 308 of graph 302 may show triangular neurons may be calculated as representors (as opposed to the triangular neurons being fit). Such a graph may be able to capture experiences as neurons. As such, each neuron may represent a single experience. Such a graph may provide a basis for describing data.

Graph 304 may include multiple simplexes. Each simplex may represent one or more experiences. Section 310 of graph 304 may show that pattern identification may form a single consistent simplex. The single, consistent simplex may be comprised of multiple triangular neurons, such as those shown in graph 302. The simplex may assume that all experiences are competitive. The simplex may handle errors by adding, for each error, an additional dimension to the simplex.

Graph 306 may include multiple simplexes. Each simplex may represent one or more experiences. The entirety of graph 306 may show a tessellated simplex. The tessellated simplex may transform unconnected representations into data relationships and data segments. The tessellated simplex may form a hierarchical topology and/or ontology learned from data. The tessellated simplex may use pattern identification to convert topology to neurons. The neurons may be compiled to form one or more neural networks.

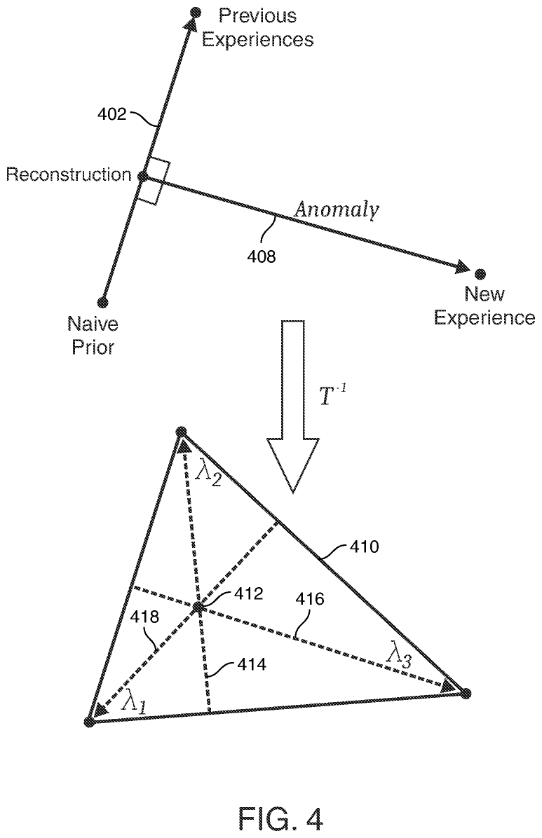

FIG. 4 shows an illustrative diagram. The diagram shows a naïve prior. It should be noted that any other suitable prior may be used in such an example. The naïve prior may be projected onto previous experiences, as shown at 402. When the naïve prior is projected onto previous experiences, which may be referred to as reconstruction, a reconstruction error value may be generated. It should be noted that the reconstruction error value may be the value in which the new experience does not match any previous experiences. As such, the reconstruction error value may identify the new experience, as shown at 408.

Point a, shown at 21, may indicate the naïve prior, point b, shown at 22, may indicate the previous experience and point c, shown at 13, may indicate the new experience. A line segment from the naïve prior to the previous experiences may be encoded by a neuron. The point of reconstruction may represent the new experience projected onto line segment that encodes the naïve prior to the previous experiences. The line segment that encodes the reconstruction anomaly to the new experience, as shown at 408, may be represented by a neuron that may encode the reconstruction to the new experience.

The line segments may be transformed into a simplex using the following method: generate a coactivation matrix of line segments: naïve prior to previous experiences and reconstruction anomaly to new experience; invert the coactivation matrix to generate an inverse coactivation matrix; multiply the weights of the neurons by the inverse coactivation matrix; this may convert the neurons from neurons that encode anomalies to neurons that encode a simplex. The thresholds may be recalculated.

Another method may be as follows: take points λ₁, λ₂ and λ₃, push points λ₁, λ₂ and λ₃ through the neurons that encode point λ₁, line segment naïve prior to previous experiences and line segment reconstruction anomaly to new experience to generate a coactivation matrix. The coactivation matrix is inverted. The coactivation matrix inverse is multiplied by the weight matrix to yield a weight prime matrix. In order to get a threshold prime, one can solve for point: λ₁, maximizing the λ₁ neuron, point λ₂ maximizing the λ₂ neuron and point λ₃ maximizing the λ₃ neuron. The result may be the simplex, or combination space.

Dotted lines 414, 416 and 418 show the definition of the combination space, from a corner of the simplex to the opposite line.

Point 412 shows the middle point of the simplex. A data point that is plotted in the middle of the simplex corresponds to a maximally unsure model. An example of a data structure that may be plotted at point 412, may be a data structure that has 33.33% correspondence to point λ₁, 33.33% correspondence to point λ₂, 33.33% correspondence to point λ₃.

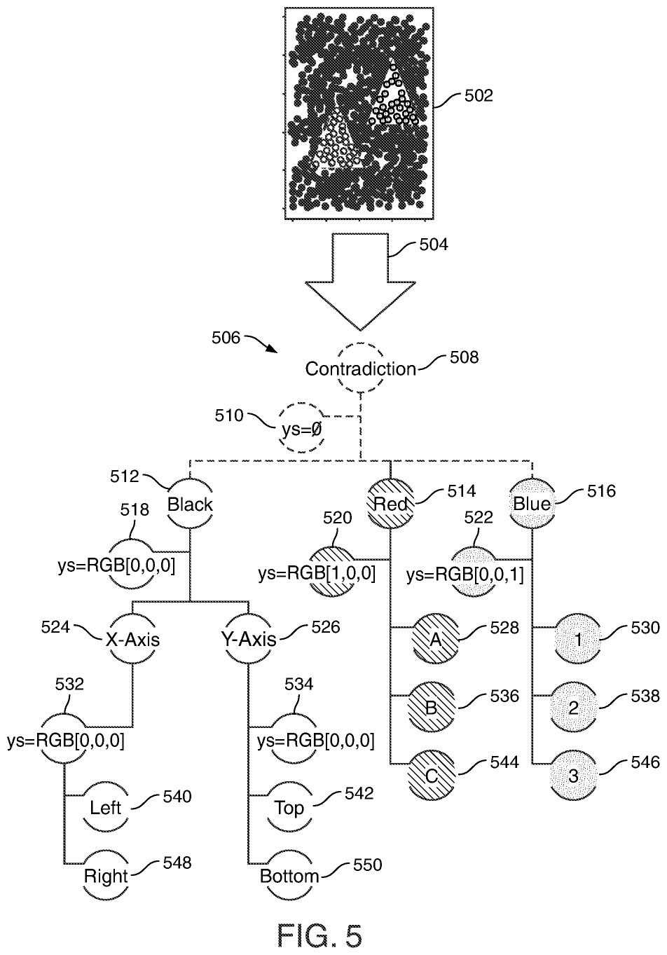

FIG. 5 shows an illustrative diagram. The illustrative diagram shows a topology of a foliated simplicial complex. A topology may be understood to be a mapping. Such a topology may be represented as a tree. The nodes, or leaves, of the tree may sort data in a top-down manner. The nodes may also classify data in a bottom-up manner using neurons. As such, a tree may be understood to express ontologically a data grouping and decisions associated with data included in the data grouping. For example, an ontology may correspond to a dictionary for a specific discipline.

An ontology tree may be visualized as a graph that includes one or more parent nodes. Each of the one or more parent nodes may include one or more child nodes. Child nodes may be a subset of the parent nodes. Child nodes may also carry more specific data than parent nodes. The ontology tree may be expandable. As such, the tree may learn how a reconstruction anomaly (or mistake) may fit into the existing ontology and/or how the existing ontology may be amended to include the reconstruction anomaly.

A compiler may convert one or more data points within a specified topology into neurons. It should be noted that, using a specified topology and/or ontology to convert data points to neurons may not include an iterative correction process. As such, learning may be mostly completed within a single iteration. Reducing a learning process from multiple iterations to a single iteration may reduce processing time and computing resources wasted in multiple iterations of a learning process.

Graph 502 may include a plurality of pixels. Each pixel included in graph 502 may be assigned a red green blue (“RGB”) color identifier. Arrow 504 shows that graph 502 may be divided into its component parts using foliated simplicial complex 506. Contradiction 508 may be a first node on complex 506. Contradiction 508 may be assigned a non-zero value, as shown at node 510. Graph 502 may be shown as initiated with contradiction 508 to identify a set, or ontology, occupied by the plurality of pixels.

Each pixel, included in the plurality of pixels, shown in graph 502, may be either a black pixel (shown at 512), a red pixel (shown at 514) or a blue pixel (shown at 516). It should be noted that pixels may also be white and/or green. However, the pixels included in graph 502 may be included in either a black grouping, a red grouping or a blue grouping. As such, the foliated simplicial complex may include the applicable nodes. Additionally, in the event that a green or white pixel is added to graph 502, the foliated simplicial complex may be amended to include nodes associated with the additional pixels. Furthermore, the additional nodes may be added in a bottom-up manner (from the bottom layer of the complex) as opposed to requiring traversal of the entire foliated simplicial complex.

Black node 512 may be assigned an RGB value of [0,0,0], as shown at node 518. Node 518 may include an attribute (the RGB value) of node 512. Black node 512 may be a parent node to child nodes 524 and 526. As such, black node 512 may be located on the X-axis (node 534) or on the Y-axis (node 526).

X-axis node 524 may be assigned an RGB value of [0,0,0], as shown at node 532. Node 532 may include an attribute (the RGB value) of node 524. X-axis node 532 may be a parent node to child nodes 540 and 548. As such, X-axis node 524 may be located on a left side (node 540) or on a right side (node 548).

Y-axis node 526 may be assigned an RGB value of [0,0,0], as shown at node 534. Node 534 may be an attribute (the RGB value) of node 526. Y-axis node 534 may be a parent node to child nodes 542 and 550. As such, Y-axis node 526 may be located on a top side (node 542) or on a bottom side (node 550).

Red node 514 may be assigned an RGB value of [1,0,0], as shown at node 520. Node 520 may be an attribute (the RGB value) of node 514. Red node 514 may be a parent node to nodes 528, 536 and 544. Node 528, encoding attribute A, node 536, encoding attribute B and node 544, encoding attribute C, may be child nodes of parent node 514.

Blue node 516 may be assigned an RGB value of [0,0,1], as shown at node 522. Node 522 may be an attribute (the RGB value) of node 516. Blue node 516 may be a parent node to nodes 530, 538 and 546. Node 530, encoding attribute 1, node 538, encoding attribute 2 and node 546, encoding attribute 3, may be child nodes of parent node 516.

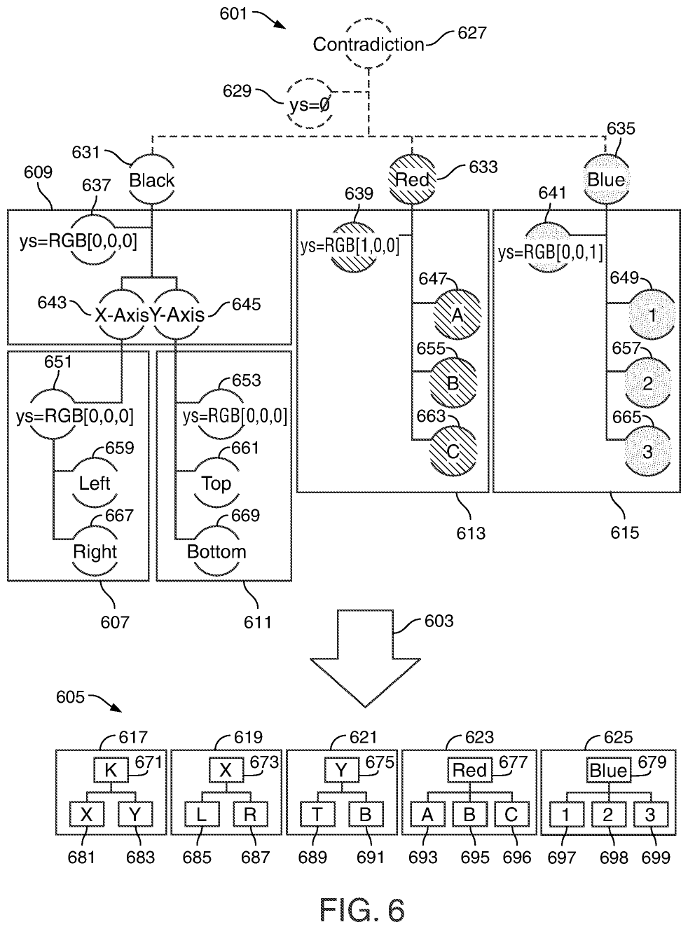

FIG. 6 shows an illustrative diagram. The illustrative diagram shows flattening a foliated simplicial complex into a flattened neural network. It should be noted that a width of the flattened neural network may be expanded when compared to simplicial complex (or tree).

Complex 601 may be comparable to complex 506, included in FIG. 5. As such, node 627 may correspond to node 508, node 629 may correspond to node 510, node 631 may correspond to node 512, node 633 may correspond to node 514, node 635 may correspond to node 516, node 637 may correspond to node 518, node 639 may correspond to node 520, node 641 may correspond to node 522, node 643 may correspond to node 524, node 645 may correspond to node 526, node 647 may correspond to node 528, node 649 may correspond to node 530, node 651 may correspond to node 532, node 653 may correspond to node 534, node 655 may correspond to node 536, node 657 may correspond to node 538, node 659 may correspond to node 540, node 661 may correspond to node 542, node 663 may correspond to node 544, node 665 may correspond to node 546, node 667 may correspond to node 548 and node 669 may correspond to node 550.

Complex 601 may be transformed, as shown at arrow 603, into flattened neural network 605. Each decision within complex 601 may be framed. Each frame included in complex 601 may be shown within flattened neural network 605.

Frame 609 may correspond to the decision of whether black node 631 is on the X-axis or is on the Y-axis. The RGB attribute, shown at 637 may not be included in the decision (or fork) and therefore may not be shown in the flattened neural network. Frame 609 may correspond to frame 617 within neural network 605. Neuron 671 may correspond to black node 631. Neuron 681 may correspond to node 643. Neuron 683 may correspond to node 645.

Frame 607 may correspond to the decision of whether X-axis node 643 is on a left side or is on a right side. The RGB attribute, shown at 651 may not be included in the decision (or fork) and therefore may not be shown in the flattened neural network. Frame 607 may correspond to frame 619 within neural network 605. Neuron 673 may correspond to x-axis node 643. Neuron 685 may correspond to left side node 659. Neuron 687 may correspond to right side node 667.

Frame 611 may correspond to the decision of whether Y-axis node 645 is on a top side or is on a bottom side. The RGB attribute, shown at 653 may not be included in the decision (or fork) and therefore may not be shown in the flattened neural network. Frame 611 may correspond to frame 621 within neural network 605. Neuron 675 may correspond to y-axis node 645. Neuron 689 may correspond to top side node 661. Neuron 691 may correspond to bottom side node 669.

Frame 613 may correspond to the decision of red node 633 includes attributes A, B or C. The RGB attribute, shown at 639 may not be included in the decision (or fork) and therefore may not be shown in the flattened neural network. Frame 613 may correspond to frame 623 within neural network 605. Neuron 677 may correspond to red node 633. Neuron 693 may correspond to attribute A (node 647). Neuron 695 may correspond to attribute B (node 655). Neuron 696 may correspond to attribute C (node 663).

Frame 615 may correspond to the decision of whether blue node 635 includes attributes 1, 2 or 3. The RGB attribute, shown at 641 may not be included in the decision (or fork) and therefore may not be shown in the flattened neural network. Frame 615 may correspond to frame 625 within neural network 605. Neuron 679 may correspond to blue node 635. Neuron 697 may correspond to attribute 1 (node 649). Neuron 698 may correspond to attribute 2 (node 657). Neuron 699 may correspond to attribute 3 (node 665).

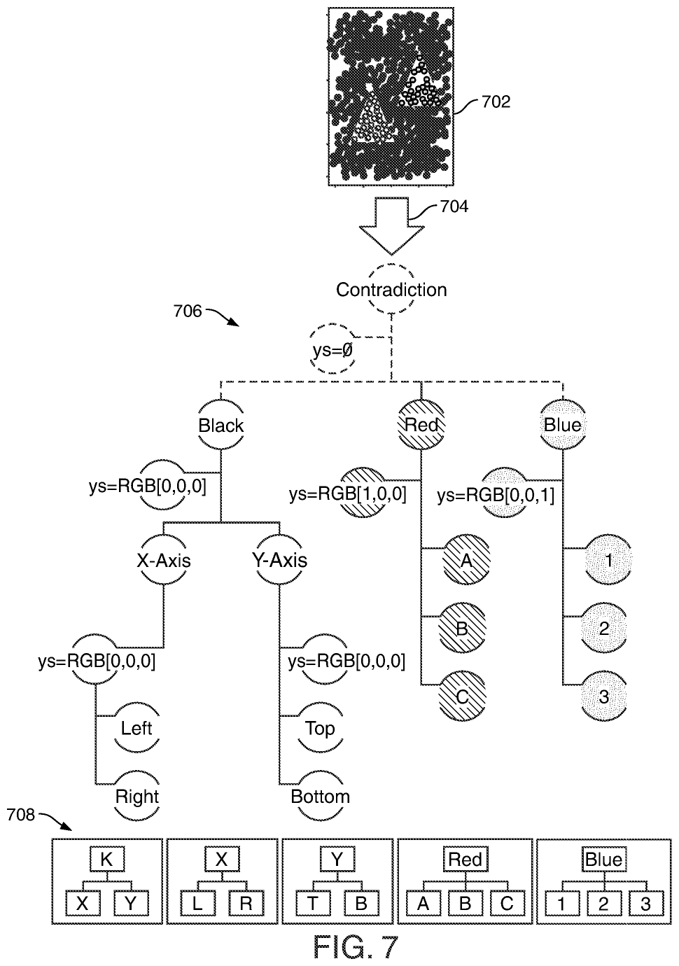

FIG. 7 shows another illustrative diagram. The illustrative diagram shows a complete process from graph 702 which follows to complex 706 (indicated by arrow 704) which follows to neural network 708. Neural network 708 may be a flattened neural network and used to process additional data graphs and/or elements.

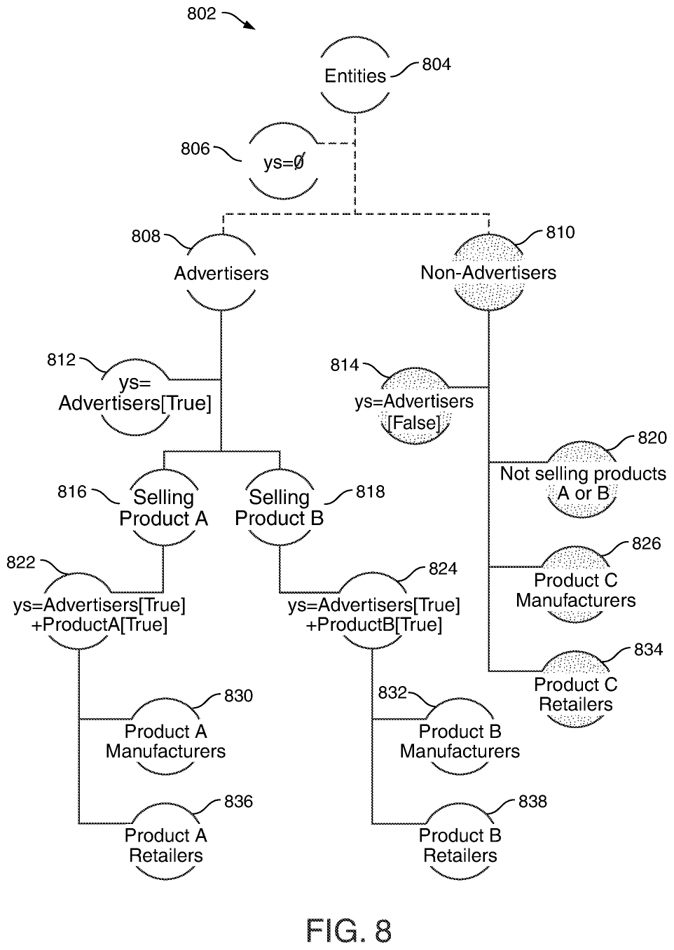

FIG. 8 shows another illustrative diagram. The illustrative diagram shows a foliated simplicial complex. The foliated simplicial complex identifies component parts of an entity. Entities node 804 may be a parent node in complex 802. Complex 802 may include nodes categorize one or more entities. Node 804 may be assigned a non-zero baseline attribute as shown at node 806.

Each entity included in complex 802 may be either an advertiser as shown at node 808, or a non-advertiser as shown at node 810. When the entity is an advertiser (shown at node 808), the node may be assigned an attribute of advertisers being true as shown at node 812. The attribute of assigning true to the advertisers (ys=Advertisers [True]) may be a mandatory attribute.

Node 808 may be a parent node to child nodes 816 and 818. As such, advertisers may either be selling product A (shown at node 816), or product B (shown at node 818).

Advertisers may be selling product A (shown at node 816). Advertisers may have an attribute of being an advertiser and selling product A, as shown at node 822. The attribute of being an advertiser and selling product A may be a mandatory attribute. Node 816 may be a parent node to child nodes 830 and 836. As such, an advertiser selling product A may either be a product A manufacturer (shown at node 830) or a product A retailer (shown at node 836).

Advertisers may be selling product B (node 818). It should be noted that, according to complex 802, advertisers cannot sell both product A and product B. Advertisers may have an attribute of being an advertiser and selling product B, as shown at node 824. The attribute of being an advertiser and selling product B may be a mandatory attribute. Node 818 may be a parent node to child nodes 832 and 838. As such, an advertiser selling product B may either be product B manufacturer (shown at node 832) or a product B retailer (shown at node 838).

An entity may be a non-advertiser, as shown at node 810. As such, the entity may be assigned an attribute of advertiser equal to false, as shown at node 814. Node 810 may be a parent node to child nodes 820, 826 and 834. Non-advertisers may not sell products A or B (as shown at node 820). Non-advertisers may be a product C manufacturer (as shown at node 820). Non-advertisers may be a product C retailer (as shown at node 834). It should be noted that non-advertisers that do not sell products A or B may be an attribute of non-advertisers. Therefore, a non-advertiser may not sell products A or B and may be a product C manufacturer or a product C retailer. However, a non-advertiser may not be both a product C manufacturer and a product C retailer.

Thus, systems and methods for tessellated simplex pattern identification processor are provided. Persons skilled in the art will appreciate that the present invention can be practiced by other than the described embodiments, which are presented for purposes of illustration rather than of limitation. The present invention is limited only by the claims that follow.

What is claimed is:

1. A method for operating a neural network on one or more processors, the method comprising:
creating a neural network that represents a data universe, wherein:
the neural network comprises a plurality of neurons;
each neuron within the neural network represents a data point;
each of the neurons in the neural network being sorted in a hierarchical tree, the sorting within the neural network based on attributes of the data points; and
the hierarchical tree includes a plurality of decision forks, each decision fork included in the hierarchical tree representing a differentiator between a data point type that categorizes the data points.

2. The method of claim 1 further comprising:
receiving an additional data point to append to the hierarchical tree;
receiving metadata relating to a categorization of the additional data point;
converting the additional data point to a neuron; and
adding the neuron to the hierarchical tree at a bottom edge of the hierarchical tree.

3. The method of claim 1 further comprising flattening out the hierarchical tree into a flattened neural network, where each decision fork in the hierarchical tree is parallel to each other decision fork in the hierarchical tree.

4. The method of claim 3 wherein the flattened neural network is not greater than four neuron layers.

5. The method of claim 4 wherein the four layers comprise:
a first layer corresponding to an input layer;
a second layer corresponding to a decision query included in the decision fork;
a third layer corresponding to a decision response included in the decision fork; and
a fourth layer corresponding to an output layer that combines the decision responses from the third layer.

6. The method of claim 5 wherein the second layer and the third layer are hidden layers.

7. The method of claim 5 further comprising searching the flattened neural network using parallel processing.

8. The method of claim 5 further comprising changing an output of the flattened neural network based on a less than a predetermined amount of added data points.

9. A neural network representing a data universe, the neural network comprising:
a plurality of neurons;
wherein:
each neuron included in the plurality of neurons represents a data point;
each neuron included in the neural network is sorted in a hierarchical tree based on attributes of the data points;
the hierarchical tree includes the plurality of neurons and a plurality of decision forks; and
each decision fork included in the hierarchical tree represents a differentiator between a data point type that categorizes the data points.

10. The neural network of claim 9 wherein the neural network is operable to:
receive an additional data point to append to the hierarchical tree;
receive metadata relating to a categorization of the additional data point;
convert the additional data point to a neuron; and
add the neuron to the hierarchical tree at a bottom edge of the hierarchical tree based on the categorization of the additional data point.

11. The neural network of claim 9 wherein the neural network is operable to convert the hierarchical tree into a flattened neural network, where each decision fork in the hierarchical tree is parallel to each other decision fork in the hierarchical tree.

12. The neural network of claim 11 wherein the flattened neural network replaces the neural network.

13. The neural network of claim 12 wherein the flattened neural network is not greater than four neuron layers.

14. The neural network of claim 13 wherein the four neuron layers comprise:
a first layer corresponding to an input layer;
a second layer corresponding to a decision query included in the decision forks;
a third layer corresponding to a decision response included in the decision forks, said decision response being selected from the plurality of neurons; and
a fourth layer corresponding to an output layer that combines the decision responses from the third layer.

15. The neural network of claim 14 wherein the second layer and the third layer are hidden layers.

16. The neural network of claim 13 wherein the flattened neural network is searched using parallel processing.

17. The neural network of claim 13 wherein an output of the flattened neural network is changed based on less than a predetermined amount of added data points.

18. The neural network of claim 17 wherein the predetermined amount of added data points is ten.

19. A method for operating a neural network on one or more processors, the method comprising:
creating a neural network, wherein:
the neural network comprises a plurality of neurons;
each neuron within the neural network represents a data point;
each of the neurons in the neural network being sorted in a hierarchical tree, the sorting within the neural network based on attributes of the data points; and
the hierarchical tree includes a plurality of decision forks, each decision fork included in the hierarchical tree representing a differentiator between a data point type that categorizes the data points;
receiving an additional data point to append to the hierarchical tree;
receiving metadata relating to a categorization of the additional data point;
converting the additional data point to a neuron; and
adding the neuron to the hierarchical tree at a bottom edge of the hierarchical tree;
flattening out the hierarchical tree into a flattened neural network, where each decision fork in the hierarchical tree is parallel to each other decision fork in the hierarchical tree; and
replacing the neural network with the flattened neural network.

20. The method of claim 19 wherein the flattened neural network is not greater than four neuron layers.
